(19) United States
(12) Patent Application Publication
(10) Pub. No.: US 2019/0232363 A1
(43) Pub. Date: Aug. 1, 2019

(54) CLAY BINDER MATERIALS AND METHODS OF PREPARATION THEREOF

(71) Applicant: S & B Industrial Minerals North America, Inc., Roswell, GA (US)

(72) Inventors: Jie LU, Lompoc, CA (US); Victor S. LAFAY, Cincinnati, OH (US); Michael GREENE, Santa Barbara, CA (US)

(21) Appl. No.: 16/311,344

(22) PCT Filed: Jun. 19, 2017
(86) PCT No.: PCT/US17/38091

§ 371 Date: Dec. 19, 2018

Related U.S. Application Data
(60) Provisional application No. 62/352,098, filed on Jun. 20, 2016.

(51) Int. Cl. B22C 1/18; B28C 1/10; C09C 1/42

(52) U.S. Cl. CPC B22C 1/181; C09C 1/42; B28C 1/10

(57) ABSTRACT

Clay materials useful as binding agents in green sandcasting and other molding processes are discussed, as well as methods of preparing such clay materials. The clay materials may be chemically treated. For example, a natural clay may be combined with one or more reducing agents, such that an amount of iron present as ferric iron (Fe³⁺) in the natural clay is at least partially reduced to ferrous iron (Fe²⁺) in the chemically-treated clay. The chemically-treated clay may exhibit greater water absorption, binding properties, and/or sintering properties as compared to an untreated, natural clay.

### CLAIM FOR PRIORITY

This PCT International Application claims the benefit of priority of U.S. Provisional Application No. 62/352,098, filed Jun. 20, 2016, the subject matter of which is incorporated herein by reference in its entirety.

### TECHNICAL FIELD

Embodiments of the present disclosure relate generally to clay materials useful as binding agents, e.g., during casting, pelletizing, molding, and/or other processes for shaping an article.

### BACKGROUND

Casting is a foundry process for preparing articles in which a heated liquid material, often a metal or metal alloy, is poured into the cavity of a mold and allowed to cool in the shape of the cavity. The casted article is then released from the mold. Various materials can be used to form the mold, e.g., depending on the nature of the material to be cast. Sand casting, for example, is useful for casting metals and metal alloys. In this process, sand is typically combined with a binding agent and formed into the desired mold shape. Forming such sand molds can be done by compacting the sand mixture around a pattern (e.g., a replica of the article to be cast) and removing the pattern to leave a cavity with the desired shape and configuration. A flask may be used to hold the sand mold before and/or during casting. Sprues, gates, and vents also may be formed in the sand to allow for controlled introduction of molten metal into the mold. Once the molten metal is poured into the mold and cooled to solidify, the casted metal article may be released, often by breaking down the sand mold.

Green sand casting refers to the use of wet or moistened sand to form the mold, wherein sand is typically combined with water and a binding agent such as clay to form the molding medium. Binding agents are sometimes provided as a “pre-mix” that can be combined with a local source of sand to produce the molding medium. The binding agent generally allows the sand particles to cohere, such that the mold can maintain its shape and withstand stress applied throughout the casting process. During green sand casting, the sand mold typically retains some amount of moisture, with clay serving as an adhesive at both ambient and elevated temperatures.

The chemical composition of a sand mold generally dictates its properties, including its ability to withstand the stress and pressure of the casting process, which in turn, affects the quality of the cast article. Different compositions of the molding medium used to prepare a mold can have a significant impact on the ability of the mold to perform under the high temperature and compression conditions of sand casting. In particular, the surface of the mold in contact with the molten material dictates the texture and quality of the surface of the cast article that is ultimately extracted from the mold. Reproducibility during green sandcasting generally depends on various factors such as shrinkage and/or other changes in the dimensions of the mold cavity, the hardness of the mold, the stability of the sand molding medium, mechanical alignment of the flask, and the casting temperature, including any variations in temperature.

A common problem in sandcasting is the production of articles with surface defects that cause those articles to be rejected. For example, grains of silica sand typically expand upon heating. When the grains are too close during casting, the molding sand can move as it expands to cause defects in the cast article, such as “buckles” (long, shallow indentations resulting from excessive sand expansion), “rat tails” (thin, irregular indentations also resulting from sand expansion), and “scabs” (raised areas on the casting due to a portion of the molding sand breaking away when molten metal enters the mold).

Various methods have been used in an effort to avoid or prevent these types of surface defects, such as the use of additives like carbonaceous materials to eliminate uneven expansion of the sand, or starch to enhance the dry strength of the mold. Because clay typically contracts with heat, the properties of the clay used in the sand molding medium also can affect the stability of the mold, especially at high temperatures when molten metal is pouring into the mold.

### SUMMARY

The present disclosure includes methods of treating clay materials and compositions comprising such treated clay materials. The clay materials may be chemically treated such as chemically reduced, e.g., by the addition of one or more reducing agents. In some aspects, for example, the method comprises combining a first clay with at least one reducing agent to produce a treated clay, wherein the first clay comprises montmorillonite, and an amount of iron present as ferric iron (Fe³⁺) in the first clay is at least partially reduced to ferrous iron (Fe²⁺) in the treated clay. The first clay may comprise bentonite, such as, e.g., sodium bentonite, calcium bentonite, or a combination thereof. The first clay may be obtained from a natural clay deposit, e.g., a natural bentonite deposit. Thus, for example, the first clay may be a natural clay. In other examples contemplated herein, the first clay may be at least partially processed prior to the addition of the at least one reducing agent.

The first clay may be an activated clay, e.g., comprising an activated sodium bentonite, an activated calcium bentonite, or a combination thereof. In at least some examples, the treated clay may comprise at least 1500 ppm of total acid soluble iron, such as at least 2000 ppm, at least 2500 ppm, or at least 3000 ppm of total acid soluble iron. For example, the treated clay may comprise from about 1500 ppm to about 6000 ppm, from about 1800 ppm to about 5500 ppm, or from about 2000 ppm to about 5000 ppm of total acid soluble iron. The ratio of Fe²⁺ to Fe³⁺ of the treated clay may be greater than 3, such as greater than 5, greater than 7, or greater than 10.

In some aspects of the present disclosure, the at least one reducing agent may be chosen from sulfite compounds (including, but not limited to, sodium sulfite), organic acids (including, but not limited to, ascorbic acid, formic acid, oxalic acid, and tannic acid), thiourea, sodium borohydride (NaBH₄), lithium aluminum hydride (LiAlH₄), carbon monoxide (CO), phosphite compounds, hypophosphite compounds, tin compounds, or a combination thereof. In at least one example, the at least one reducing agent comprises a sulfite compound, an organic acid, a hydride compound, or a combination thereof. For example, the at least one reducing agent may comprise sodium sulfite.

The at least one reducing agent may be added in an amount ranging from about 0.01% to about 10.0% by weight with respect to the weight of the first clay, such as from about 0.1% to about 5.0% by weight. The method may further comprise adding soda ash to the first clay. The soda ash may be added before, at the same time, or after the first clay is combined with the at least one reducing agent. In some aspects, the soda ash may be added in an amount ranging from about 1% to about 15% by weight, with respect to the weight of the first clay.

According to some aspects of the present disclosure, the treated clay may have a swelling volume ranging from about 20 ml/2 g to about 50 ml/2 g, or from about 30 ml/2 g to about 45 ml/2 g. Additionally or alternatively, the treated clay may have a compression strength ranging from about 200 N to about 700 N. The treated clay may be suitable for use in a molding process, e.g., as a binding agent. Such molding processes may include, for example, sandcasting (e.g., green sandcasting), pelletization (e.g., iron ore pelletization), or brick making. In some aspects, for example, the method may further comprise combining the treated clay with sand to form a clay/sand mixture, and preparing a mold from the clay/sand mixture.

The present disclosure also includes compositions comprising chemically-treated clay materials, e.g., chemically-reduced clay materials. For example, the composition may comprise a chemically-treated bentonite clay having a swelling volume greater than 20 ml/2 g and less than about 60 ml/2 g, such as greater than about 30 ml/2 g and less than about 50 ml/2 g. In some aspects, the chemically-treated bentonite clay may have an average compression strength ranging from about 400 N to about 500 N.

The composition may comprise a chemically-treated bentonite clay comprising iron in different oxidation states. For example, the chemically-treated bentonite clay may have a ratio of Fe²⁺ to Fe³⁺ greater than 3, such as greater than 5, greater than 7, or greater than 10. Additionally or alternatively, the composition may comprise an additive that comprises Fe²⁺, F³⁺, or a combination of Fe²⁺ and Fe³⁺. Thus, for example, the ratio of Fe²⁺ to Fe³⁺ of the treated clay and/or of the additive may be greater than 3, greater than 5, greater than 7, or greater than 10. In some examples, the composition may comprise at least 1500 ppm of total acid soluble iron, such as at least 2000 ppm, at least 2500 ppm, or at least 3000 ppm of total acid soluble iron. For example, the composition may comprise from about 1500 ppm to about 6000 ppm, from about 1800 ppm to about 5500 ppm, or from about 2000 ppm to about 5000 ppm of total acid soluble iron.

In some aspects, the chemically-treated clay may be prepared by combining a first clay with at least one reducing agent chosen from sodium sulfite, ascorbic acid, or thiourea. The first clay may be obtained from a natural clay deposit, e.g., a natural bentonite deposit. Thus, for example, the first clay may be a natural clay. In other examples contemplated herein, the first clay may be at least partially processed prior to the addition of the at least one reducing agent.

According to some aspects of the present disclosure, the composition may additionally comprise sand, e.g., silica sand. For example, the composition may comprise from about 85% to about 97% of the sand by weight, and from about 3% to about 15% of the chemically-treated bentonite clay by weight. In some aspects, the composition may contain moisture, e.g., the composition comprising from about 2% to about 4% of water by weight with respect to the weight of the sand.

In at least one example, the composition may be prepared by combining a natural bentonite clay with at least one reducing agent to produce the chemically-treated bentonite clay, wherein an amount of iron present as ferric iron (Fe³⁺) in the natural bentonite clay is reduced to ferrous iron (Fe²⁺) in the chemically-treated bentonite clay. The at least one reducing agent may be added in an amount ranging from about 0.01% to about 10.0% by weight with respect to the weight of the natural bentonite clay. Additionally or alternatively, the at least one reducing agent may be chosen from sulfite compounds (including, but not limited to, sodium sulfite), organic acids (including, but not limited to, ascorbic acid, formic acid, oxalic acid, tannic acid, citric acid, and phytic acid), thiourea, sodium borohydride (NaBH₄), lithium aluminum hydride (LiAlH₄), carbon monoxide (CO), phosphite compounds, hypophosphite compounds, tin compounds, or a combination thereof.

The present disclosure further includes a composition comprising a chemically-reduced bentonite clay, wherein the composition comprises at least 1500 ppm of total acid soluble iron and a ratio of Fe²⁺ to Fe³⁺ greater than 3. In some examples, the ratio of Fe²⁺ to Fe³⁺ may be greater than 5, greater than 7, or greater than 10. The chemically-reduced bentonite clay may be an activated bentonite clay. In some aspects, the composition may comprise an additive that comprises Fe²⁺, Fe³⁺, or a combination of Fe²⁺ and Fe³⁺. Any of the compositions herein may be used in a sandcasting process and/or a pelletization process.

### BRIEF DESCRIPTION OF THE DRAWINGS

The accompanying drawings, which are incorporated in and constitute a part of this specification, illustrate various exemplary aspects of the disclosure, and together with the description, serve to explain the principles of the present disclosure.

FIG. 1 shows X-ray diffraction patterns for several exemplary clay materials in accordance with some aspects of the present disclosure.

FIGS. 2, 3, and 4 are charts comparing swelling volumes measured for several clay materials, as discussed in Example 4.

FIGS. 5 and 6 are charts comparing compression strength values measured for several clay materials, as discussed in Example 5.

FIG. 7 is a chart comparing durability values determined for several clay materials, as discussed in Example 6.

### DETAILED DESCRIPTION

Particular aspects of the present disclosure are described in greater detail below. The terms and definitions provided herein control, if in conflict with terms and/or definitions incorporated by reference.

As used herein, the terms “comprises,” “comprising,” or any other variation thereof are intended to cover a non-exclusive inclusion, such that a process, method, composition, article, or apparatus that comprises a list of elements does not include only those elements, but may include other elements not expressly listed or inherent to such process, method, composition, article, or apparatus. The term “exemplary” is used in the sense of “example” rather than “ideal.”

As used herein, the singular forms “a,” “an,” and “the” include plural reference unless the context dictates otherwise. The terms “approximately” and “about” refer to being nearly the same as a referenced number or value. As used herein, the terms “approximately” and “about” should be understood to encompass ±5% of a specified amount or value.

Clay is a generic term that encompasses a range of hydrous alumino-silicate minerals of varying chemical composition and properties. The chemical composition of clay minerals usually includes iron, magnesium, calcium, alkali metals, and other cations, in various amounts. Exemplary clay materials suitable for the compositions herein include, but are not limited to, bentonite, kaolinite, illite, chlorite, sepiolite-palygorskite, ball clay, hectorite, and mixtures thereof. One of the main components of bentonite is montmorillonite, a phyllosilicate clay having a layered structure of an octahedral sheet of alumina between two tetrahedral sheets of silica. Different types of bentonite are typically named after the dominant compositional element, such as sodium bentonite, calcium bentonite, potassium bentonite, lithium bentonite, and aluminum bentonite. Kaolinite is a layered silicate mineral having one tetrahedral sheet of silica linked through oxygen atoms to one octahedral sheet of alumina. The compositions herein may comprise clay materials in addition to, or as an alternative to, bentonite or kaolinite.

As mentioned above, clay materials may be useful as binders in forming green sand molds in the metal casting industry and in pelletizing ores, e.g., iron ores. In green sandcasting, for example, clays are typically mixed with water, sand, and optionally one or more additives to produce the green sand molding medium. High amounts of water may lead to excessive vapor generation when molten material is pouring into the mold during casting, which, in turn, may lead to defects due to release of the vapor. Thus, the minimum amount of water that gives the highest molding strength may be desired.

Properties of Clay Materials as Binding Agents

A clay binder with good gelatinization or high swelling properties may require low amount of water addition to achieve the same desired binding strength, because high swelling may generate more contact points between clay and sand particles when the clay is wetted, thus lead to more binding surfaces among the particles. On the other hand, a low amount of clay may only be needed for the desired mold strength or sintering strength for pelletization if the clay used has higher swelling properties.

Further, the stability and strength of green sand molds, especially under the high temperature and compression conditions of sandcasting, also may depend partially, or even primarily, on the sintering strength of the clay used. Sintering generally refers to the compacting of a material by application of heat and/or pressure, without melting the material. Sintering strength is also a consideration in iron ore pelletization, where the properties of the clay binder material may dictate its ability to bind finely pulverized ores.

Clays providing a higher binding strength and/or better sintering properties under high temperatures, for example, may provide for more stable molds and thus fewer casting defects as compared to clays with lower binding and sintering capabilities. Sintered clays that exhibit contraction or shrinkage that helps to compensate expansion of sand upon application of heat during sandcasting also may lend stability and/or strength to the mold. Clays such as bentonite may provide plasticity to the molding medium, and may be capable of withstanding the higher temperatures of sand casting without degradation of the clay's chemical structure. During the final evaporation of moisture from the green sand mold, for example, solid mortar bridges may be formed with increasing strength. This dehydration of bentonite may be accompanied by a shrinkage, which may increase the adhesion forces among particles.

Bentonite swells when mixed with water and increases the viscosity of the molding medium. In the presence of water, for example, sodium montmorillonite can swell to as much as 20 times its own volume. This high swelling potential of montmorillonite is reportedly attributed to repulsive forces and interlayer expansion in the presence of hydrated cations and water molecules in electrolyte solutions. Calcium bentonite tends to be less absorbent. Other clays such as clays of the kaolinite group, may exhibit little or no swelling on hydration.

A commercial example of a water-swellable clay is Volclay@ DC-2 Western Bentonite produced by AMCOL. Natural/raw deposits of bentonite may absorb less water, despite similarities in elemental composition to DC-2 (see, e.g., Examples 1 and 2, below).

Chemical Compositions of Clay Materials

These differences in the swelling characteristics of different clay materials may be related to their chemical compositions, e.g., to the kind and degree of isomorphous replacements in their structures, including the amount and/or nature of their associated exchangeable cations. In clay minerals such as montmorillonite, the cations include sodium and alkaline earth cations, including Ca²⁺ and Mg²⁺, as well as iron in its different oxidation states, namely Fe²⁺ (ferrous iron), and Fe³⁺ (ferric iron). Indeed, iron makes up a considerable fraction of bentonite, e.g., in comparable amounts to sodium, calcium, and magnesium. Natural deposits of sodium bentonite may comprise less than about 0.6% total soluble iron, e.g., only about 0.1%-0.2% total soluble iron with a relatively low amount of ferrous iron, e.g., a ratio Fe²⁺/F³⁺ less than 3. The relative concentrations of ferrous and ferric iron reflect the redox state of the bentonite. Ferrous iron is generally more soluble than ferric iron, the solubility of the latter being dependent on pH. The chemical compositions of DC-2 and some exemplary natural (unprocessed) bentonite clays appear in Table 1 of Example 1 below.

The loss-on-ignition (LOI) value is the difference in weight of a material before and after heating it at a high temperature (“igniting” the material), in particular the temperatures used during casting. For example, cast iron generally requires a temperature of about 1427° C. (˜2600° F.). The LOI provides an indication of the amount of combustible material in the clay material(s) and/or sand mold, e.g., reflecting the amount of material that volatilizes and decomposes upon heating. LOI measurements therefore may provide useful information about the composition of a binder composition and/or green sand composition.

Upon hydration, the dissociation of the associated cations of a clay material leaves some of the structural units negatively charged. Thus charged, the units tend to repel each other. Thus, for example, upon hydration montmorillonite may appear to swell. In general, the more complete the dissociation and the greater the number of units carrying a charge, the greater the swelling may be expected. Conversely, the less complete the dissociation, the fewer are the units carrying a charge, and the less swelling may result.

Chemical Treatment of Clay Materials

Some compositions according to the present disclosure may comprise one or more clay materials that may be chemically modified, e.g., by at least one reducing agent. For example, the exchangeable ferric iron in the clay material(s) may be at least partly reduced in oxidation state to ferrous iron (Fe³⁺ e⁻→Fe²⁺) through the addition of at least one reducing agent. Some compositions according to the present disclosure may comprise a first clay material and a second clay material, wherein the first clay material has a higher amount of total soluble iron and/or a higher ratio of ferrous iron to ferric iron (Fe²⁺/Fe³⁺) than the second clay material. The first clay material may be chemically modified or, in some examples, may be a natural clay. Additionally or alternatively, the compositions may comprise one or more clay materials and one or more additives providing an additional source of iron, e.g., an iron additive such as iron oxide, among other iron compounds. For example, the additive(s) may increase the total amount of iron in the compositions and/or provide for a higher ratio of ferrous iron to ferric iron (Fe²⁺/Fe³⁺) in the compositions. The additive(s) may be chemically-modified, e.g., by at least one reducing agent.

The addition of reducing agent(s) according to the methods herein may increase the acid soluble iron contents of the compositions (e.g., increasing the amount of soluble iron in the clay material(s) and/or in the additive(s)). In some aspects, for example, the addition of reducing agent(s) according to the methods herein may more than double the acid soluble iron contents of the compositions (e.g., increasing the amount of soluble iron in the clay material(s) and/or the amount of soluble iron in the additive(s)), increasing the amount of acid soluble iron about 5-fold. Without intending to be bound by theory, reduction of iron in the clay material is expected to lead to more negative charges in the clay's structural units, in turn suggesting greater repulsion in the interlayers of the clay mineral structure. For example, when the iron has been reduced, even only a small fraction in the tetrahedral and octahedral layers, the more negatively-charged layers that result may have greater repulsion towards one another. This repulsion may lead to an increase in hydration properties due to greater absorption of water (swelling). Reduction of the ferric iron present in the interlayers of the clay material may lead to reduced bonding strength of the adjacent layers (e.g., due to one less shared bond), which also may facilitate the wet expansion (swelling) of the interlayers.

Further, the compositions and methods herein may provide for binder compositions with improved binding and/or thermal properties. Again without intending to be bound by theory, the reduction treatment of the clay materials used as binding agents may be at least partially due to a re-oxidation mechanism during heating. For example, the heating process in casting may include oxidation, wherein oxidative species tend to be oxidized by oxygen under heat. For clay binders comprising iron species largely present as ferrous iron, oxidation during the process may lead to the formation of ferric irons (Fe²⁺→e⁻+Fe³⁺), which may help to form additional, stronger bonds to the iron species in the clay. The addition of one or more reducing agents may increase of the total amount of acid soluble cations. The soluble or activated cations can contribute to the binding strength once the clays are heated, thus improving the casting performance., e.g., providing for stronger and/or more stable sand molds.

The compositions herein may be useful as binding agents in sand casting processes and other processes that use binding agents, such as, e.g., iron ore pelletization and/or brick making (see discussion below). The clay materials and compositions prepared according to some aspects of the present disclosure may provide for one or more of the following advantages: improved binding properties and/or sintering properties; greater green compression strength, hot compression strength, dry compression strength, and/or wet tensile strength; better surface finish and/or shakeout of casted articles, improved flowability of the green molding medium, and/or faster actuation and/or developing speed during sandcasting.

Exemplary clay materials suitable for the compositions herein include, but are not limited to, bentonite, kaolinite, illite, chlorite, sepiolite-palygorskite, ball clay, hectorite, and mixtures thereof. For example, the composition may comprise at least one bentonite clay chosen from sodium bentonite, calcium bentonite, potassium bentonite, lithium bentonite, aluminum bentonite, or a mixture thereof. In some aspects, the composition may comprise one or more clay materials chosen from sodium bentonite, calcium bentonite, potassium bentonite, aluminum bentonite, kaolinite, hectorite, ball clay, or a mixture thereof. For example, the composition may comprise sodium bentonite, a mixture of sodium bentonite and calcium bentonite, a mixture of sodium bentonite and kaolinite, or a mixture of sodium bentonite, calcium bentonite, and kaolinite, among other mixtures of clay materials. The compositions herein may comprise clay materials in addition to, or as an alternative to, bentonite and/or kaolinite clays. In at least some examples, the composition does not comprise Volclay® DC-2 Western Bentonite.

The clay material(s) may be obtained from any geographic region or regions. For example, the composition may comprise two or more clay materials mined or otherwise obtained from different geographic regions, countries, or states/provinces. For example, clay materials according to the present disclosure may be obtained from the western, mid-western, and/or southern regions of the United States (including, but not limited to, Wyoming, Montana, South Dakota, Indiana, Michigan, Wisconsin, Ohio, Mississippi, and Alabama), South Africa, Greece, Germany, Turkey, China, Korea, Taiwan, Indonesia, Thailand, Japan, India, Russia, the Ukraine, Mexico, Brazil, and Australia, among other countries and geographic regions worldwide. The clay materials may be in particulate or powder form, or other solid form.

Bentonite clays useful for the present disclosure may comprise at least 50% by weight montmorillonite, such as at least 55% by weight, at least 60% by weight, at least 65% by weight, at least 70% by weight, at least 75% by weight, or at least 80% by weight montmorillonite. For example, the bentonite clay may comprise from about 50% to about 90% montmorillonite by weight, such as from about 60% to about 90% by weight, or from about 70% to about 90% montmorillonite by weight. According to some aspects of the present disclosure, the composition may comprise a sodium bentonite clay optionally in combination with one or more other clay materials, wherein the sodium bentonite clay comprises at least 70% by weight montmorillonite, e.g., from about 70% to about 90% by weight montmorillonite.

Reducing Agents

Exemplary reducing agents suitable for the present disclosure may include, but are not limited to, sulfite compounds such as sodium sulfite (Na₂SO₃) and other sulfite compounds, sodium thiosulfate (Na₂S₂O₃), thiourea (SC(NH₂)₂), formamidine sulfinic acid (NH₂C(NH₂)SO₂H) (FAS; also known as thiourea dioxide), organic acids such as ascorbic acid, formic acid, oxalic acid, tannic acid, citric acid, and phytic acid, among other organic acids, hydrides (including borohydrides) such as LiAlH₄ and NaBH₄, among other hydrides, and sodium formaldehyde sulfoxylate (NaSO₂CH₂OH), among other reducing agents known in the chemical arts. In some examples, a combination of two or more of any of the foregoing reducing agents may be used. The reducing agent(s) may be added in dry form, in solution, or both in dry form and in solution.

The amount of reducing agent added may range from about 0.01% to about 10.0% by weight with respect to the weight of the clay material, such as from about 0.05% to about 7.5% by weight, from about 0.1% to about 5.0% by weight, from about 0.5% to about 4.5% by weight, from about 1.0% to about 4.0% by weight, from about 1.5% to about 3.0% by weight, with respect to the weight of the clay material.

In some aspects of the present disclosure, soda ash may be added to the clay material(s) in addition to, or as an alternative to, the reducing agent(s). The amount of soda ash may range from about 1% to about 15%, such as from about 5% to about 10%. Soda ash may be used according to some methods herein in an activation process to produce sodium bentonite from calcium bentonite. According to some aspects, the addition of one or more reducing agents as disclosed herein may be combined with the soda ash activation process of making sodium bentonite from calcium bentonite.

Reducing agents may be added to the clay materials by any suitable method that allows for reaction with the clay materials. For example, the reducing agent may be mixed or mulled with the clay material and the resulting mixture allowed to set for a period of time (e.g., at least 30 minutes, 1 hour, 3 hours, 6 hours, 12 hours, 18 hours, 24 hours, 30 hours, or 36 hours). In at least one example, the amount of reducing agent added may be less than 5% by weight, with respect to the weight of the clay material.

In other aspects of the present disclosure, the clay material may be mixed or mulled with soda ash (sodium carbonate, Na₂CO₃) prior to, or together with, the reducing agent. For example, the reducing agent may be blended with the soda ash and spread over the clay material. The resulting mixture of clay material, soda ash, and reducing agent may be allowed to set for a period of time, e.g., at least 24 hours. In at least one example, soda ash (1% to 15% by weight) and a reducing agent (0.1% to 5% by weight) may be added to the clay material at the same time, and the resulting mixture allowed to set for at least 24 hours.

In yet other aspects of the present disclosure, a solution of the reducing agent may be prepared in water or other suitable solvent, and the solution added to the clay material. The clay material may be dried and mulled, e.g., for use as a binding agent. For example, the clay material may be dried to a moisture content of less than about 20%, e.g., with a range of about 3% to about 18%, or from about 5% to about 15%, and then mulled. In at least one example, the amount of reducing agent added to the clay material may range from 0.1% to 5% by weight, with respect to the weight of the clay material. In some examples, an aqueous solution ranging from about 1% by weight to about 99% by weight of reducing agent(s) may be added to the clay material(s). For example, the solution of reducing agent(s) may range from about 10% to about 90% by weight of the reducing agent(s), from about 20% to about 80% by weight, or from about 25% to about 75% by weight. In at least one example, a solution of 25% sodium sulfite by weight in water may be used. The solution of reducing agent(s) may be combined with the clay material(s) alone or with the clay material(s) in combination with sand and/or additives. In some aspects, the water in an aqueous solution of reducing agent(s) may be the source of water to adhere particles of the clay material(s) and/or sand together in a molding medium.

The methods disclosed herein may provide for clay materials with properties similar to, or better than, those of clay materials currently available. In some aspects, the clay materials disclosed herein may have improved absorption/swelling properties, binding properties, and/or thermal properties. For example, chemical modification of the clay material through treatment with one or more reducing agents (alternatively referred to herein as reductive activation, iron activation, or “reductive bleaching”) may increase the hydration properties of the clay materials, e.g., such that the swelling of the chemically-modified clay material is increased, and nearly doubled in some cases. Further, the treated clay materials herein may exhibit enhanced performance as binding agents useful in sandcasting and other high-temperature molding processes. For example, the binding strength and thermal performance of the clay materials (e.g., as measured by compression strength, after high temperature sintering) may be better than binding agents currently available.

The swelling volume (or swell index) of a clay material may be measured as an indication of the material's ability to absorb water as discussed above, with implications regarding the amount of water and clay suitable for a binder composition and the ability of the binder composition to allow sand particles to cohere in a green sand mold. Swelling volume (in ml/2 g) may be measured according to the standard ASTM D-5890. The clay materials chemically treated as disclosed herein may have a swelling volume ranging from about 20 ml/2 g to about 50 ml/2 g, such as from about 30 ml/2 g to about 45 ml/2 g, or from about 40 ml/2 g to about 45 ml/2 g.

The compression strength of a binding material may be used to evaluate the material's performance under elevated temperatures as an indication of binding and sintering properties. Compression strength may be measured for sintered clay pellets according to the standard ASTM 4179-01. The clay materials chemically treated as disclosed herein may have a compression strength ranging from about 100 N to about 700 N, such as from about 200 N to about 650 N, from about 200 N to about 500 N, from about 300 N to about 600 N, or from about 400 N to about 500 N.

Ore Pelletization

In some aspects of the present disclosure, the clay materials may be used as binding agents in a pelletization process, such as, e.g., iron ore pelletization. In the mining industry, finely-ground mineral ore concentrate, such as, for example, iron oxide particles, may be pelletized or agglomerated to facilitate the handling and shipping of the ore. In some aspects of the present disclosure, the treated clay materials may be mixed with water and a particulate ore to form pellets. Such ores may include iron ores, such as taconite, hematite, specularite, magnetite, and/or other ores useful in iron-making. Taconite, for example, is a high-grade iron ore that comprises fine-grained silica mixed with magnetite and hematite. To recover the ore mineral in a usable form for the production of iron, taconite may be finely ground, and the magnetite or hematite concentrated by a magnetic or other process. The concentrate may be agglomerated into pellets of a size and strength suitable for a blast furnace.

Some characteristic properties of iron ore pellets bound with the water-swellable clay materials disclosed herein include ballability, the balling characteristics (kinetics) of the ore-water-clay mixture; wet compression strength of the pellet; resistance to fracture by impact (e.g., drop test); deformation under load; resistance to over-wetting of the pellet surface by recondensation of moisture; resistance to decrepitation (shock temperature), e.g., sudden pellet-spalling occurring when pellets are heated too rapidly; and dry compression strength. The clay materials herein may have moisture binding ability providing control over the amount of moisture of the ore/clay mixtures during the pelletization process.

The pellets prepared with the clay binder materials herein may provide sufficient strength to avoid significant or substantial pellets of the agglomerates during handling between the pelletization process and use of the pellets, such as smelting in an iron-making furnace. In some examples, the pellets may have sufficient strength that they do not break or crack as they are handled and shipped to a location where they can be sintered or otherwise further processed. Compression strength may be measured by compressing or applying pressure to a random sampling of pellets until the pellets crumble or otherwise break.

Green Sand Compositions

In some aspects of the present disclosure, the clay materials used as binding agents may be moistened to activate the binding properties of the clay, and the hydrated clay combined with sand to serve as a green sand molding medium. Examples of sand that may be used in the compositions and methods herein include, but are not limited to, silica sand (SiO₂), olivine sand ((Fe, Mg)₂SiO₄), chromite sand (FeCr₂O₄), and zircon sand (ZrSiO₄), any of which optionally may include other elements such as magnesium, aluminum, manganese, and/or carbon (graphite). Other types of sand are likewise contemplated and may be used in the compositions herein without departing from the principles of the present disclosure. The composition and gradation of sand may be selected based at least in part on the composition of the material to be cast, the temperature of casting, and/or the availability of sand obtained from a local source. The cohesive strength of the sand molding medium may be most evident in its “green” condition, that is, when it is moistened.

In some aspects, the green sand may comprise one or more additives. Examples of such additives suitable for the green sand compositions herein include, but are not limited to, carbonaceous materials (e.g., lignite, bituminous coal such as, e.g., sea coal and Flocarb®, a naturally-occurring organic material produced by AMCOL), polymers, surfactants, iron oxide, cellulose (e.g., ground plant products), corn cereal, and starches. Carbonaceous materials may provide several benefits in green sandcasting. For example, carbonaceous material on and immediately adjacent the mold cavity surface may decompose under the heat of the molten metal as it is poured into the mold. A product of this decomposition is elemental carbon (e.g., graphite) at the interface between the mold cavity and molten metal, which can help in releasing the cast article from the mold (e.g., shakeout) and produce a smoother surface on the cast article. Further, for example, carbonaceous material(s) may increase flowability of the molding medium and/or increase the permeability of the mold.

In some examples, a “pre-mix” or binder composition comprising one or more clay materials and one or more additives above may be prepared and combined with sand and moistened with water to produce the green sand. In some aspects of the present disclosure, the pre-mix composition may comprise one or more clay materials and one or more reducing agents. Alternatively, the green sand may be prepared by combining, in any order, the one or more clay materials, sand, and water, along with any additives. Any of the types and combinations of materials discussed above may be used for the sand molds herein. The clay material(s), sand, water, and any other additives of the green sand may be combined or mulled together, e.g., via a muller or using another suitable machine or method for providing a uniform green sand mixture.

In at last one example, the reducing agent(s) may be added into a pre-mix composition comprising one or more clay materials and one or more additives, and allowed to react to form a chemically-modified pre-mix composition. The pre-mix composition thus may comprise chemically-modified clay material(s) and/or chemically-modified additive(s), which then may be combined with sand. In another example, the reducing agent(s) may be combined with the clay material(s) alone to form chemically-modified clay material(s) before the addition of any additives or sand. In yet another example, the reducing agent(s) may be combined with the clay material(s), additive(s), and sand at the same or approximately the same time.

A typical green molding sand composition may comprise from about 85% to about 97% silica sand, from about 3% to about 15% clay material(s) (as binding agent(s)), water, and other additives as mentioned above. In some aspects, the green sand composition (green sand molding medium) may comprise from about 2% to about 4% water by weight with respect to the weight of the sand. Thus, for example, the green sand composition may comprise by weight, from about 86% to about 90% sand, from about 8% to about 10% bentonite clay (which may be chemically treated with one or more reducing agents as discussed above), from about 2% to about 4% organic additives or other additives, and from about 2% to about 4% water.

According to some aspects of the present disclosure, the green sand used as the molding medium may comprise from about 75% to about 95% sand by weight, such as from about 80% to about 90% by weight, or from about 85% to about 90% sand by weight, with respect to the total weight of the green sand. Further, for example, the green sand may comprise from about 5% to about 20% of binder materials (including, e.g., bentonite clays and any additives) by weight, such as from about 8% to about 16%, from about 10% to about 15% by weight, with respect to the total weight of the green sand. The green sand may further comprise water providing for a moisture content ranging from about 1.8% to about 2.5% by weight, such as from about 1.8% to about 2.2% by weight or from about 2.0% to about 2.4% by weight, e.g., a moisture content of about 1.8%, about 1.9%, about 2.0%, about 2.1%, about 2.2%, about 2.3%, about 2.4%, or about 2.5% by weight, with respect to the total weight of the green sand.

Green Sand Molds

Methods of preparing or forming a sand mold according to the present disclosure may include use of a pattern or replica of the article to be cast with the mold. The pattern may be formed of plastic, wood, metal, or other suitable material or combination of materials. In some aspects, for example, green sand as discussed above may be shaped around the pattern such that the green sand adopts the shape of the pattern. The pattern then may be removed to form the mold by leaving a cavity in the shape of the pattern. In other aspects, the pattern may be pressed into the green sand and then removed, forming the mold by leaving a cavity in the shape of the pattern.

The chemical composition and physical characteristics of the green sand may affect its “workability” and ability to compact around the pattern. Flowability generally refers to the capacity of the green sand to flow freely around the pattern, e.g., to provide an appropriate density (e.g., ease with which densification may be attained) while avoiding voids at the sand/mold interface that can reduce the quality of the casted article. Green sands according to the present disclosure may have a flowability that overcomes friction between the green sand and the surface of the pattern while providing the appropriate amount of contact with the pattern to provide for high mold strength.

After being compacted to define a cavity, green sands according to the present disclosure may have sufficient strength to withstand any forces incident to removal of the pattern, such that the cavity design or configuration remains intact. The green sands also may have sufficient strength to withstand the forces incident to moving and positioning the sand mold as it is being formed and/or any hydraulic forces incident to pouring the heated material (e.g., molten metal or metal alloy) into the cavity.

The sand mold may be incorporated into a gating system, or other suitable system or mechanism, for introducing a heated liquid material such as a molten metal or metal alloy into the cavity. The heated liquid material thus may be poured into the mold cavity with the appropriate rate of flow and temperature upon entering the cavity. Exemplary materials that may be used for the casted articles herein include, but are not limited to, iron, aluminum, steel, bronze, brass, magnesium, zinc, and combinations thereof.

The green sand mold may be at least partially dried upon introduction of the heated material into the cavity. The mold may have sufficient permeability to help in preventing damage to the mold upon heating. As the heated material is poured into the mold cavity, air and/or other gases may be displaced through the green sand. Because the green sand is moistened, steam may be generated upon exposure to the heated material, for example. To accommodate the generation of air and/or other gaseous materials generated upon heating, the green sand of the mold may have a suitable permeability that allows the gas to vent with a minimum of gas flow resistance in order to preserve the integrity of the mold. In some aspects, the sand mold may have a relatively high gas permeability.

After pouring the heated liquid material into the mold cavity, the liquid may be allowed to cool such that the cooled material adopts the shape of the cavity. The casted article thus formed may be removed from the sand mold by any suitable method, such as breaking away the sand mold. As mentioned above, the incorporation of carbonaceous materials may assist in removal of the casted article from the sand mold.

Various analyses may be used to characterize green sands and green sand molds to assess their capacity to produce casted articles with the appropriate quality. In addition to the flowability and permeability characteristics described above, green sands may be characterized or evaluated by such properties as compactability, moisture content, permeability, green compression strength, green shear strength, dry compression strength, hot compression strength, and wet tensile strength, among other parameters. The standard sample size for testing green sands is generally a cylinder having a diameter of 50.8 mm (2 in.) and a height of 50.8 mm (i.e., a cylindrical sample 2 in. by 2 in.), or a cylinder having a diameter of 50 mm and a height of 50 mm.

Green compression strength refers to the pressure required to rupture a sample at compressive loading. Green sands according to the present disclosure may have a green compression strength ranging from about 4.0 N/cm² to about 15.0 N/cm², such as from about 7.0 N/cm² to about 10.0 N/cm². The green compression strength may be measured at ambient temperature (˜25° C.). In some aspects, the molding mixture may be heated at elevated temperatures (˜550° C.) and allowed to cool prior to measuring the green compression strength, e.g., at ambient temperature (˜25° C.).

Wet tensile strength is a useful metric for determining the ability of the sand mold to resist scabbing, or the undesirable formation of projections or roughness on casted articles. During casting, water from the sand adjacent to the molten metal is driven back, creating a condensation zone between the dry and wet sand. The strength of the sand in this layer is considered the wet tensile strength. Higher wet tensile values correspond to less propensity towards scabbing. Green sands according to the present disclosure may have a wet tensile strength at ambient temperature (˜25° C.) ranging from about 0.005 N/cm² to about 0.600 N/cm², such as from about 0.050 N/cm² to about 0.550 N/cm², from about 0.100 N/cm² to about 0.500 N/cm², from about 0.200 N/cm² to about 0.400 N/cm², or from about 0.225 N/cm to about 0.325 N/cm². Further, green sands according to the present disclosure may have a wet tensile strength at elevated temperature (˜550° C.) ranging from about 0.003 N/cm2 to about 0.450 N/cm2, such as from about 0.050 N/cm2 to about 0.400 N/cm2, from about 0.100 N/cm² to about 0.250 N/cm², or from about 0.150 N/cm² to about 0.200 N/cm².

Comparison of the green compression strength and wet tensile strength values at ambient vs. elevated temperatures provides an indication of the durability of a sand mold (ratio of the measured value at high temperature to the measured value at ambient temperature). Higher percentages indicate more durable green molds. For example, the green sand compositions herein may provide greater than 50% durability in green compression strength, such as greater than 60%, greater than 70%, greater than 80%, greater than 90%, or greater than 95% durability. Further, for example, the green sand compositions herein may provide greater than 40% durability in wet tensile strength, such as greater than 50%, greater than 60%, greater than 70%, or greater than 80% durability.

The compositions herein may comprise two or more different clay materials to combine beneficial properties associated with each material. For example, two or more clay materials may be combined to achieve a desired combination of permeability, green compression strength, and/or dry compression strength in the sand mold. For example, a sodium bentonite clay may be combined with a calcium bentonite clay and/or a kaolinite clay, e.g., thus combining the high dry compression strength of the sodium bentonite clay with the high green compression strength of the calcium bentonite clay and the low permeability of the kaolinite clay.

Other aspects and embodiments of the present disclosure will be apparent to those skilled in the art from consideration of the specification and practice of the embodiments disclosed herein.

### EXAMPLES

The following examples are intended to illustrate the present disclosure without, however, being limiting in nature. It is understood that the present disclosure encompasses additional aspects and embodiments consistent with the foregoing description and following examples.

### Example 1: Chemical Composition

The chemical compositions of bentonite clays from three different deposits in Wyoming (clay materials A, B, and C) were measured as received and compared to that measured for Volclay@ DC-2 (AMCOL). Bulk chemical compositions were measured by X-ray fluorescence (XRF) with an ARL ADVANT′XP Wavelength-Dispersive X-Ray Fluorescence Spectrometer (Thermo Scientific), and by X-ray powder diffraction (XRD) using a Philips X′Pert X-ray Diffractometer (PANalytical).

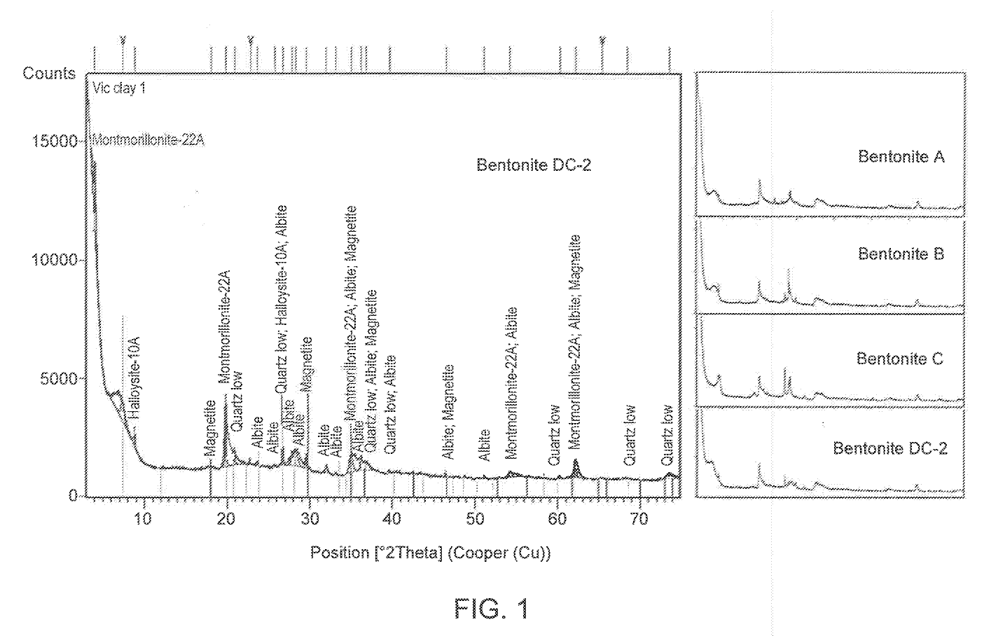

XRF data are shown in Table 1; note that total iron (Fe⁺² and Fe⁺³) is reported as Fe₂O₃. XRD data are shown in FIG. 1, where the large graph to the left shows the XRD pattern and chemical species identified for DC-2, and the four smaller graphs to the right compare the XRD patterns for the as-received (untreated) bentonite clays A, B, and C to that of the DC-2 bentonite clay.

TABLE 1
Chemical composition of clay materials

| Chemical Species | DC-2 | A | B | C |
|---|---|---|---|---|
| SiO₂ (%) | 60.07 | 58.62 | 57.50 | 64.78 |
| Al₂O₃ (%) | 24.24 | 23.25 | 23.14 | 22.47 |
| Fe₂O₃ (%) | 5.45 | 6.98 | 7.13 | 5.09 |
| MgO (%) | 3.40 | 3.71 | 3.66 | 2.49 |
| CaO (%) | 3.18 | 2.74 | 3.29 | 1.94 |
| Na₂O (%) | 2.17 | 2.09 | 2.50 | 1.87 |
| K₂O (%) | 0.61 | 0.51 | 0.51 | 0.22 |
| S (%) | 0.42 | 1.64 | 1.70 | 0.29 |
| TiO₂ (%) | 0.21 | 0.19 | 0.18 | 0.16 |
| P₂O₅ (%) | 0.10 | 0.10 | 0.09 | 0.08 |
| Total (%) | 99.85 | 99.82 | 99.70 | 99.39 |
| Mean LOD (%) | 9.11 | 11.83 | 11.74 | 10.13 |
| Mean LOI (%) | 8.49 | 7.71 | 7.64 | 6.38 |

LOD = loss on drying;
LOI = loss on ignition

The clay materials were found to be similar in mineralogical composition, e.g., comprising montomorillonite with minor contents of impurities, such as quartz and albite. The montmorillonite formula for each sample was calculated according to the method of Ross and Hendricks (1945), and are shown in Table 2.

TABLE 2
Calculated montmorillonite formulas

| Clay | Montmorillonite formula |
|---|---|
| DC-2 | {(Na + K)_{0.08}, Ca_{0.11}}[Al_{1.43}Fe_{0.25}Mg_{0.31}] [Al_{0.32}Si_{3.68}]O₁₀(OH)₂ |
| A | {(Na + K)_{0.08}, Ca_{0.10}}[Al_{1.34}Fe_{0.33}Mg_{0.34}] [Al_{0.36}Si_{3.64}]O₁₀(OH)₂ |
| B | {(Na + K)_{0.09}, Ca_{0.12}}[Al_{1.34}Fe_{0.34}Mg_{0.34}] [Al_{0.38}Si_{3.62}]O₁₀(OH)₂ |
| C | {(Na + K)_{0.07}, Ca_{0.07}}[Al_{1.48}Fe_{0.23}Mg_{0.22}] [Al_{0.11}Si_{3.89}]O₁₀(OH)₂ |

### Example 2: Swelling and Compression Strength of Untreated Clays

The swelling volumes (swelling index) of the DC-2 bentonite and the natural, untreated bentonite clays A, B, and C as received were measured in a method modeled after ASTM D-5890, wherein a 2-g oven-dried sample of each clay material was mixed with 50 ml of 0.5 M H₂SO₄ solution thoroughly in a 50-mL volumetric vial. After 2 hours of settlement, the volume of the hydrated clay was recorded, where the swelling volume was determined in units ml/2 g.

To measure compression strength of each clay material, a 1-g sample was added to a 4.5-ml ceramic crucible and the clay material tapped flat on the surface. The crucible was heated at 1000° C. for 2 hours, and after cooling, the pellet formed inside of the crucible was recovered. The pellet axial compression crush strength was measured in a method modeled after ASTM 4179-01, wherein the axial strength of the pellets was measured by a press equipped with a pressure gauge. The average value from testing three pellets is reported in Table 3.

TABLE 3
Swelling volume and compression strength of clay materials

| Clay | Swelling Volume (ml/2 g) | Compression Strength (N) |
|---|---|---|
| DC-2 | 30.0 | 160 |
| A | 24.0 | 49 |
| B | 25.0 | 47 |
| C | 31.5 | 39 |

The DC-2 bentonite measured both higher swelling and higher sintering strength as compared to the Wyoming bentonite clays A, B, and C. While clay C exhibited a higher swelling volume, the compression (sintering) strength was lower. The compression strength of DC-2 was measured at more than three times that of each of the other bentonite clays, despite the similarities in chemical composition as discussed in Example 1.

### Example 3: Acid Soluble Iron

To explore the differences in compression strength of the DC-2 bentonite as compared to the natural, untreated bentonite clays A-C, and the extent to which activation might relate to the levels of some soluble metals, the amount of acid soluble iron in each material was measured.

The acid soluble iron contents of each bentonite clay material was determined as follows. A 2 g sample of the clay was mixed with 50 ml of 0.5 M H₂SO₄ solution and mixed thoroughly in a 50-ml Nelgene vial. After settlement of the clay particles, a 0.25 ml aliquot of the supernatant was pipetted into a 50-ml vial, and 25 ml of deionized water was added. A 1 ml aliquot of FerroZine™ (sodium 3-(2-pyridyl)-5,6-diphenyl-1,2,4-triazine-4′,4″-disulphonate) indicator was then added and mixed well. The resulting colored complex formed between ferrous ion (Fe²⁺) and FerroZine™ was measured by a spectrophotometer and used to calculate the amount of soluble ferrous iron against a soluble iron calibration curve. About 200 mg of ascorbic acid was then added to the solution (to reduce Fe³⁺ to Fe²⁺), and the resulting color measured as total iron. Results appear in Table 4.

TABLE 4
Acid soluble iron contents of clay materials

| Clay | Fe⁺² (ppm) | Total Fe (ppm) |
|---|---|---|
| DC-2 | 5209 | 5223 |
| A | 309 | 1007 |
| B | 313 | 945 |
| C | 1348 | 1469 |

Table 4 shows that the acid soluble iron content of the DC-2 bentonite was found to be 4-5 times higher than the other bentonite clays A, B, and C. Furthermore, the soluble iron of DC-2 was predominantly ferrous iron (Fe⁺²). The iron content of clay material C also was found to be largely Fe²⁺ but only about 25% the amount of DC-2.

### Example 4: Chemical Treatment

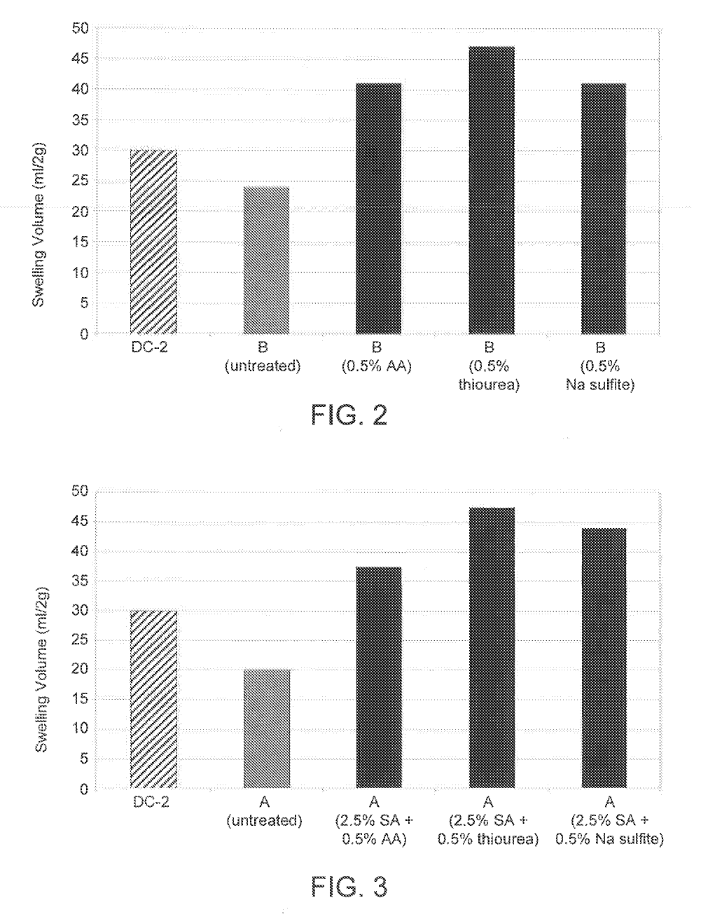

To explore the impact of chemically treating (reducing) the raw bentonite clays and assess any effects on their swelling and sintering properties, samples of bentonite clays A and B were treated with three different reducing agents: ascorbic acid (AA), thiourea, and sodium sulfite. The ferrous iron and total soluble iron contents were measured as described in Example 3, and the swelling volumes were measured as described in Example 2. Results appear in Tables 5-7 and FIGS. 2-4. Soda ash was also added to several samples (see Table 7 and FIG. 3).

For the data in Table 5, a 100 g sample of clay B was added to each of three beakers and mixed with a reducing agent: 0.05 g ascorbic acid, 0.06 g sodium sulfite, and 0.07 g thiourea, respectively. After mixing each beaker thoroughly, 50 ml of deionized water was then added, and the wetted clay/reducing agent again thoroughly mixed. The samples were then dried at 85° C. under vacuum in an oven overnight, then milled with a puck mill. The resulting mixtures were left for at least 24 hours prior to the iron and swelling volume measurements.

TABLE 5

| | | | Total | Swelling |
|---|---|---|---|---|
| | | Fe²⁺ | soluble Fe | Volume |
| Clay | Reducing agent | (ppm) | (ppm) | (ml/2 g) |
| B | — | 202 | 264 | 24.0 |
| B | 0.05% ascorbic acid | 1426 | 1462 | 40.0 |
| B | 0.06% sodium sulfite | 467 | 1342 | 40.0 |
| B | 0.07% thiourea | 1054 | 1478 | 43.0 |

For the data in Table 6, samples of clay B were mixed with soda ash and higher concentrations of the reducing agents (0.5% ascorbic acid, 0.5% thiourea, and 0.5% sodium sulfite, by weight). For these experiments, a 20 g sample of clay B was mixed with 1 g of soda ash and 0.1 g of the reducing agent, 15 ml of deionized water was added, the samples mixed thoroughly with a spatula, and then dried overnight in a 105° C. oven. After drying, the samples were milled by a puck mill prior to the iron and swelling volume measurements. FIG. 2 compares the swelling volumes and iron content of the three treated samples with a sample of untreated clay B.

TABLE 6

| | | | Total | Swelling |
|---|---|---|---|---|
| | | Fe²⁺ | soluble Fe | Volume |
| Clay | Reducing agent | (ppm) | (ppm) | (ml/2 g) |
| B | — | 587 | 1860 | 24.0 |
| B | 0.5% ascorbic acid | 2859 | 3293 | 41.0 |
| B | 0.5% thiourea | 2570 | 2970 | 41.0 |
| B | 0.5% sodium sulfite | 3084 | 3193 | 47.0 |

For the data in Table 7, a 20 g sample of each clay material (clays A and B) was mixed with 0.5 g or 1 g of soda ash (for 2.5% or 5.0% soda ash by weight as listed in Table 7), about 1 g of reducing agent (for 0.5% ascorbic acid, 0.5% thiourea, and 0.5% sodium sulfite, by weight), and 15 ml of deonized water was added. Each sample was mixed thoroughly with a spatula and dried overnight in a 105° C. oven. After drying, the samples were milled by a puck mill prior to the iron and swelling volume measurements.

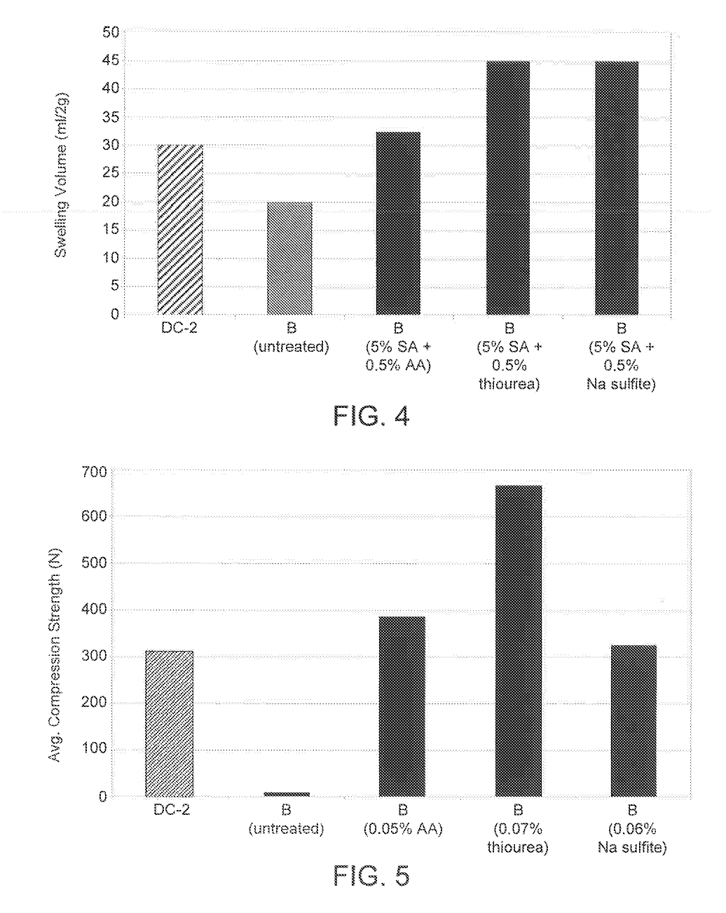

FIG. 3 compares the swelling volumes of the bentonite clay A before and after treatment with 2.5% soda ash and the reducing agents. FIG. 4 compares the swelling volumes of the bentonite clay B before and after treatment with 5% soda ash and the reducing agents. In several experiments, the untreated clay materials were mixed with water only, or with soda ash and water. These conditions did not indicate as much influence on the amount of soluble iron in the clay materials as upon adding the reducing agents.

TABLE 7

| | Soda | | | Total | Swelling |
|---|---|---|---|---|---|
| | ash | | Fe²⁺ | soluble Fe | Volume |
| Clay | (%) | Reducing agent | (ppm) | (ppm) | (ml/2 g) |
| A | — | — | 432 | 1949 | 20.0 |
| A | 2.5 | 0.5% ascorbic acid | 2826 | 3182 | 37.5 |
| A | 2.5 | 0.5% thiourea | 2592 | 3113 | 47.5 |
| A | 2.5 | 0.5% sodium sulfite | 2946 | 3691 | 44.0 |
| B | 5.0 | 0.5% ascorbic acid | 2748 | 3293 | 32.5 |
| B | 5.0 | 0.5% thiourea | 2681 | 2993 | 45.0 |
| B | 5.0 | 0.5% sodium sulfite | 3119 | 3260 | 45.0 |

The data in Table 7 suggest that reduction of certain chemical species in a foundry clay, particularly iron, leads to more swelling.

### Example 5: Compression Strength of Chemically-Treated Clays

Compression strengths for several of the bentonite samples A and B chemically treated according to Example 4 were measured both before and after the treatments. Compression strength was measured as described in Example 2.

Results for the clay materials described in Table 5 of Example 4 above (i.e., samples of bentonite clay B treated with 0.05% ascorbic acid, 0.06% sodium sulfite, and 0.07% thiourea) appear in FIG. 5, as well as compression strength values for samples of DC-2. Each reported value is the average of three measurements (three pellets).

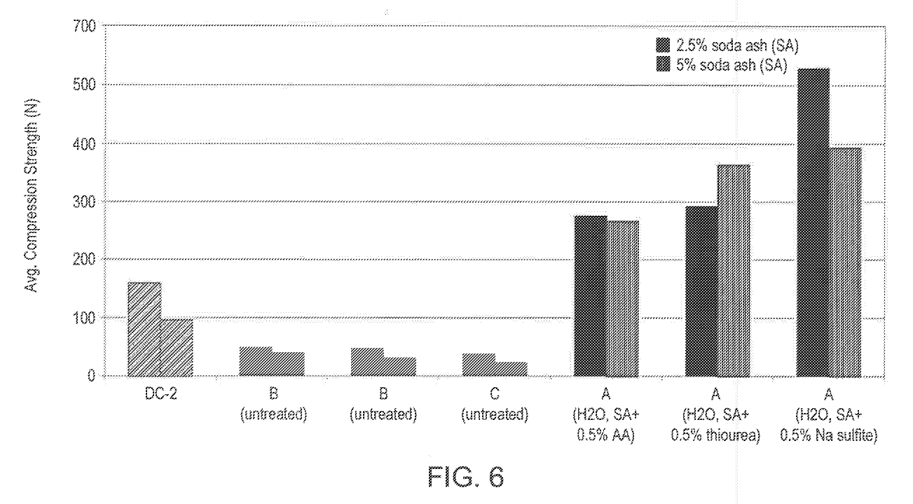

The average compression strength values for the samples of bentonite clays A and B treated with 2.5% or 5.0% soda ash and the reducing agents as described in Table 7 of Example 4 above are shown in FIG. 6. Each reported value is the average of three measurements (three pellets). In each set of compression strength measurements, the treated clay samples were compared to measurements for DC-2 and the untreated clay materials.

### Example 6: Green Compression Strength and Wet Tensile Strength

Green compression strength testing was performed for samples of untreated and treated bentonite clay C to determine the compressive stress (kN/m²) necessary to cause rupture of a standard cylindrical specimen (a cylindrical sample 2 in. by 2 in.) using a compression testing machine. Wet tensile strength was also measured for each sample.

Samples of bentonite clay C were treated with 0.5% reducing agent (sodium sulfite) by weight, 1% soda ash by weight, and both 0.5% reducing agent (sodium sulfite) and 1% soda ash. The reducing agents and soda ash were added dry to the samples of clay C.

The chemically-treated samples of bentonite clay C, an untreated sample of bentonite clay C, and a sample of DC-2 bentonite clay were prepared for green compression and wet tensile strength testing as follows. A sand-clay mixture was prepared from each clay material by adding 2000 g of dry silica sand and 100 g of the clay material to the mix-muller and mixing for 1 minute. Water was added to achieve 44-46% compactability. The mechanical mixing continued for 5 minutes, for a total mixing time of 6 minutes. The sand/clay mixture was transferred to a plastic bag and closed to prevent loss of moisture. A 150 g sample of the sand/clay mixture (moisture content 1212%, ground to approximately 85-90% minus 200 mesh) was placed in a small metallic box with cover, and transferred to a furnace (temperature 550° C.±5° C.) and heated for 2 hours. The samples were then removed for cooling and measurements.

The green compression strength of the sand/clay mixture was measured by a Green Compression Strength Equipment (cylindrical GF precision). Wet tensile strength was measured according to the testing procedures of the American Foundry Society (Mold and Core Test Handbook, “Wet Tensile Strength”). Green compression strength and wet tensile strength measurements were taken for each of four portions of the clay C samples, both at ambient temperature (˜25° C.) before heating and at ambient temperature (˜25° C.) after heating at 550° C. The averages of the four measurements for each sample are reported in Table 8.

TABLE 8

| | | | Avg. GCS | | Avg. WTS | |
|---|---|---|---|---|---|---|
| | | | (N/cm²) | | (N/cm²) | |
| | Soda | Reducing | before | after | before | after |
| Clay | ash (%) | agent (%) | heating | heating | heating | heating |
| C | — | — | 8.6 | 4.2 | 0.287 | 0.116 |
| C | — | 0.5% sodium | 7.1 | 4.5 | 0.263 | 0.113 |
| | | sulfite | | | | |
| C | 1.0 | — | 9.0 | 7.4 | 0.275 | 0.200 |
| C | 1.0 | 0.5% sodium | 8.8 | 7.7 | 0.273 | 0.210 |
| | | sulfite | | | | |

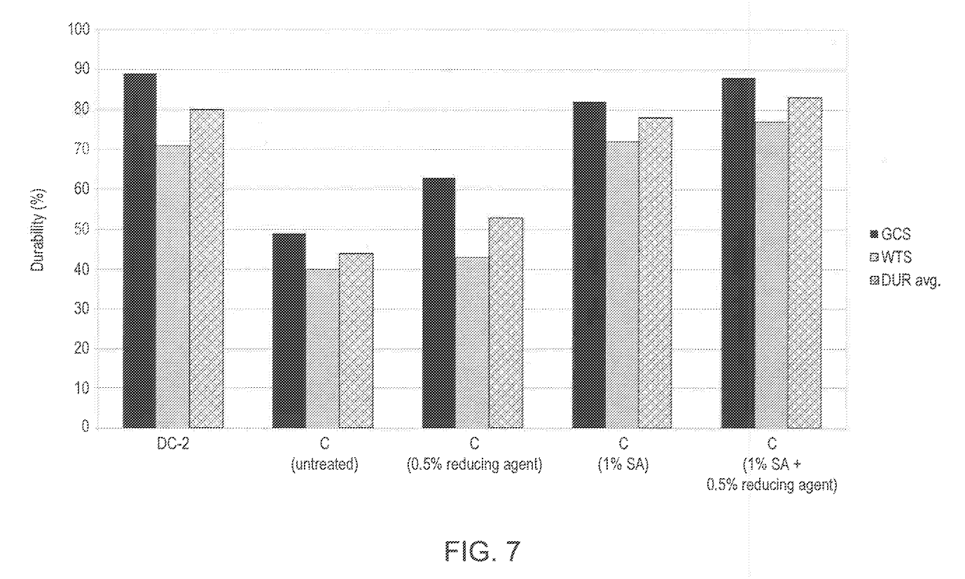

Durability values calculated from the average green compression strength (“GCS”) and wet tensile strength (“WTS”) measurements are shown in FIG. 7. In each case, durability is reported as a percentage based on the ratio of the green compression strength or wet tensile strength value measured at ambient temperature (˜25° C.) after heating at 550° C. to the value measured at ambient temperature (˜25° C.) before heating. The average of the green compression strength durability and wet tensile strength durability (“DUR avg.”) is also shown. The results indicate that the samples of clay C treated with a reducing agent exhibited higher durability. A higher durability percentage indicates that less bentonite is needed for metal casting performance (e.g., less bond (bentonite and additives) per ton of metal poured).

It is intended that the specification and examples be considered as exemplary only, with a true scope and spirit of the present disclosure being indicated by the following claims.

1-36. (canceled)

37. A method of treating a clay material, the method comprising combining a first clay with at least one reducing agent to produce a treated clay, wherein the first clay comprises montmorillonite, and an amount of iron present as ferric iron (Fe³⁺) in the first clay is at least partially reduced to ferrous iron (Fe²⁺) in the treated clay.

38. The method of claim 37, wherein the first clay comprises bentonite.

39. The method of claim 37, wherein the first clay comprises sodium bentonite, calcium bentonite, or a combination thereof, and wherein the first clay is a natural clay.

40. The method of claim 37, wherein the first clay is an activated clay and comprises an activated sodium bentonite, an activated calcium bentonite, or a combination thereof.

41. The method of any of claim 37, wherein the treated clay comprises at least 1500 ppm of total acid soluble iron.

42. The method of claim 37, wherein a ratio of Fe²⁺ to Fe³⁺ of the treated clay is greater than 3.

43. The method of claim 37, wherein the ratio of Fe²⁺ to Fe³⁺ of the treated clay is greater than 5.

44. The method of claim 37, wherein the ratio of Fe²⁺ to Fe³⁺ of the treated clay is greater than 10.

45. The method of claim 37, wherein the at least one reducing agent comprises a sulfite compound, an organic acid, a hydride compound, or a combination thereof.

46. The method of claim 37, wherein the at least one reducing agent is chosen from sodium sulfite, sodium thiosulfate, formamidine sulfinic acid, ascorbic acid, formic acid, oxalic acid, tannic acid, citric acid, phytic acid, thiourea, sodium formaldehyde sulfoxylate, sodium borohydride, lithium aluminum hydride, or a combination thereof.

47. The method of claim 37, wherein the at least one reducing agent comprises sodium sulfite.

48. The method of claim 37, wherein the at least one reducing agent is added in an amount ranging from about 0.01% to about 10.0% by weight with respect to the weight of the first clay.

49. The method of claim 37, further comprising adding soda ash to the first clay.

50. The method of claim 49, wherein the soda ash is added in an amount ranging from about 1% to about 15% by weight, with respect to the weight of the first clay.

51. The method of claim 49, wherein the soda ash is added to the first clay at a same time the first clay is combined with the at least one reducing agent.

52. The method of claim 37, wherein the treated clay has a swelling volume ranging from about 25 ml/2 g to about 50 ml/2 g.

53. The method of claim 37, wherein the treated clay has a compression strength ranging from about 200 N to about 700 N.

54. The method of claim 37, further comprising combining the treated clay with sand to form a clay/sand mixture, and preparing a mold from the clay/sand mixture.

55. A composition comprising the treated clay of claim 37, wherein the composition comprises at least 1500 ppm of total acid soluble iron.

56. A method comprising: forming an object that comprises the composition of claim 55, wherein the object is a mold, pellet, or other object for use in a casting process or a pelletization process.
